(19) United States
(12) Patent Application Publication
(10) Pub. No.: US 2012/0090466 A1
(43) Pub. Date: Apr. 19, 2012

(54) Method for Enhancing the Performance of Processes for the Removal of Acid Gas

(76) Inventors: Geert Frederic Versteeg, Enschede (NL); Patrick J.G. Huttenhuis, Enschede (NL); P.W.J Derks, Enschede (NL); S. Van Loo, Enschede (NL); Espen Steinseth Hamborg, Enschede (NL)

(21) Appl. No.: 13/322,337

(22) PCT Filed: Apr. 1, 2010
(86) PCT No.: PCT/IB2010/051430

§ 371 Date: Nov. 23, 2011

(30) Foreign Application Priority Data
Apr. 2, 2009 (ZA) 2009/02285

(51) Int. Cl. B01D 53/14

(52) U.S. Cl. 95/149

(57) ABSTRACT

The invention discloses a method for enhancing the performance of processes for the removal of acid gas wherein the dielectric constant of a solvent, being associated with a process for removing acid gas, is adjusted.

### FIELD OF INVENTION

The present invention relates to a method for enhancing the performance of processes for the removal of acid gas.

More particularly, the present invention relates to a method for enhancing the performance of processes for the removal of acid gas such as CO₂, H₂S, COS, CS₂, mercaptans.

### BACKGROUND TO INVENTION

Acid gases (also known as sour gases) include CO₂, H₂S, COS, CS₂, mercaptans, etc. The removal of these acid gases is an important step in many industrial processes.

A known technology which is frequently used to capture these sour gases is the absorber—desorber process, whereby (aqueous) solutions of basic reacting solvents, frequently encountered (alkanol) amines, are used as solvents. These processes are, however, very energy intensive, because absorption takes place at about 20-40° C. and desorption at about 100-120° C., thus a significant amount of energy is required to strip the acid gas from the solvent.

It is an object of the invention to suggest a method for enhancing the performance of processes for the removal of acid gas, which will assist in overcoming these problems.

### SUMMARY OF INVENTION

According to the invention, there is provided a method for enhancing the performance of processes for the removal of acid gas, which includes the step of adjusting the dielectric constant of a solvent associated with a process for removing acid gas.

Also according to the invention, a process for the removal of acid gas, includes the steps
(a) of passing a feed-stream through an absorber/desorber system;
(b) of adding a solvent to the system; and
(c) of adjusting the dielectric constant of the solvent in order to enhance the performance of the system.

Yet further according to the invention, an arrangement for the removal of acid gas in an acid gas removal process, includes
(a) an absorber;
(b) a desorber; and
(c) adjustment means adapted to adjust the dielectric constant of a solvent added to the process in order to enhance the performance of the system.

The dielectric constant of the solvent may be changed in the absorber, desorber and/or somewhere else in the process.

The adjustment of the dielectric constant of a solvent may influence the thermodynamic equilibrium of the process and/or the optimal operating temperature in the absorber and/or desorber.

A change of the dielectric constant of 10% may change the solubility of the acid gas by more than 30%.

The acid gas solubility may be increased in the absorber system, in order to increase the capacity of the solvent, resulting in smaller equipment and/or a lower solvent circulation rate and/or change the optimal absorber temperature.

The acid gas solubility may be decreased in the desorber system, in order to decrease the amount of energy required to strip the acid gas, decrease the size of the desorber and/or decrease the desorber temperature.

The dielectric constant of the solvent may be adjusted by at least one of the steps selected from the group consisting of:
(a) adding additional components to the solvent prior to entering the absorber or desorber column;
(b) applying an electric field to change the dielectric constant of the solvent; and
(c) applying electromagnetic waves adapted to influence the dielectric constant of a solvent.

The added additional component may be removed downstream the absorber or respective desorber.

The dielectric constant of the solvent may be decreased by adding a component which has a dielectric constant lower than water.

The dielectric constant of the solvent may be increased by adding a component with a high dielectric constant.

### DETAILED DESCRIPTION OF INVENTION

A method for enhancing the performance of processes for the removal of acid gas, in accordance with the invention, includes the step of adjusting the dielectric constant of a solvent associated with a process for removing acid gas.

Important and inevitable information for the design and operation of both absorber and desorber is the vapour-liquid equilibrium (VLE); i.e. the relation between the concentration acid gas in the absorption liquid and the partial pressure acid gas in the gas phase at equilibrium conditions.

The solvents used exhibit a substantial thermodynamically non-ideal behaviour, because the acid component reacts chemically to ionic species with the alkaline solvent. For this reason an accurate prediction of the thermodynamic equilibrium can only be obtained with rigorous thermodynamic models. In these models the non-ideality of all molecular and ionic species present in the liquid phase is incorporated, because the chemical activities of these components are calculated.

An important physical input parameter in these rigorous thermodynamic models is the dielectric constant of the solvent. During simulations with one of the rigorous thermodynamic models it has been noted that adjustment of this parameter influences the thermodynamic equilibrium significantly. It has been noted that when the dielectric constant is changed with 10% a change in acid gas solubility of more than 30% could be realized. This change in solubility can be used to manipulate and improve on the performance of these kind of acid gas treating systems. If for example the acid gas solubility is increased in the absorber system, the capacity of the solvent will increase, resulting in smaller equipment and/or a lower solvent circulation rate. If the acid gas solubility is decreased in the desorber the amount of energy required to strip the acid gas, the size of the desorber and/or the desorber temperature will be affected positively.

It has been proven experimentally that when a compound with a lower dielectric constant than that of water is added, the basic strength of the solvent and hence the acid gas solubility decreased.

Experiments were illustrated using model calculations on the absorption of CO₂ using a 40 wt % aqueous MDEA solution at 40° C. It is anticipated that this principle of adjusting the dielectric constant works for all acid gases and all solvents used in the treating of sour gas streams.

Accordingly the performance of acid gas absorption processes can be improved by changing the dielectric constant of the solvent in the absorber, desorber or somewhere else in the process. The dielectric constant of a solvent can be adjusted via several routes, including the following:
(a) By adding additional components to the solvent prior to entering the absorber or desorber column. The component should however be removed downstream the absorber or respective desorber.
(b) Lowering the solvent dielectric constant can be attained by adding a component which has a dielectric constant lower than water.
(c) Increasing the solvent dielectric constant can be achieved generally by adding a component with a high dielectric constant.
(d) By applying an electric field to change the dielectric constant. A change in the dielectric constant of water above a field intensity of 107 V/m: At very high electric field strengths, the water molecules develop specific orientations and the effective dielectric constant decreases.
(e) By applying electromagnetic waves which influences the dielectric constant of a solvent, as this property is a strong function of the frequency of electromagnetic waves (above a certain frequency). In the case of water, e.g., it is known that its dielectric constant decreases strongly at a frequency above 8 GHz.

1. A method for enhancing the performance of processes for the removal of acid gas, which includes the step of adjusting the dielectric constant of a solvent associated with a process for removing acid gas.

2. The method as claimed in claim 1, in which the dielectric constant of the solvent is changed in an absorber, desorber and/or somewhere else in the process.

3. The method as claimed in claim 1, in which the adjustment of the dielectric constant of the solvent influences the thermodynamic equilibrium of the process and/or the optimal operating temperature in the absorber and/or desorber.

4. The method as claimed in claim 1, in which a change of the dielectric constant of 10% changes the solubility of the acid gas by more than 30%.

5. The method as claimed in claim 1, in which acid gas solubility is increased in the absorber, in order to increase the capacity of the solvent, resulting in smaller equipment and/or a lower solvent circulation rate and/or change the optimal absorber temperature.

6. The method as claimed in claim 1, in which acid gas solubility is decreased in the desorber, in order to decrease the amount of energy required to strip the acid gas, decrease the size of the desorber and/or decrease the desorber temperature.

7. The method as claimed in claim 1, in which the dielectric constant of the solvent is adjusted by at least one of the steps selected from the group consisting of:
(a) adding additional component(s) to the solvent prior to entering the absorber or desorber column;
(b) applying an electric field to change the dielectric constant of the solvent;
and (c) applying electromagnetic waves adapted to influence the dielectric constant of a solvent.

8. The method as claimed in claim 1, in which the dielectric constant of the solvent is adjusted by adding additional component(s) to the solvent prior to entering the absorber or desorber and in which the added additional component(s) are removed downstream the absorber or respective desorber.

9. The method as claimed in claim 1, in which the dielectric constant of the solvent is decreased by adding a component which has a dielectric constant lower than water.

10. The method as claimed in claim 1, in which the dielectric constant of the solvent is increased by adding a component with a high dielectric constant.

11. A process for the removal of acid gas, said process comprising:
(a) passing a feed-stream through an absorber/desorber system;
(b) adding a solvent to the system; and
(c) adjusting the dielectric constant of the solvent in order to enhance the performance of the system.

12. The process as claimed in claim 11, in which the dielectric constant of the solvent is changed in the absorber, desorber and/or somewhere else in the process.

13. The process as claimed in claim 11, in which the adjustment of the dielectric constant of the solvent influences the thermodynamic equilibrium of the process and/or the optimal operating temperature in the absorber and/or desorber.

14. The process as claimed in claim 11, in which the dielectric constant of the solvent is adjusted by at least one of the steps selected from the group consisting of:
(a) adding additional component(s) to the solvent prior to entering the absorber or desorber;
(b) applying an electric field to change the dielectric constant of the solvent; and
(c) applying electromagnetic waves adapted to influence the dielectric constant of a solvent.

15. The process as claimed in claim 11, in which the dielectric constant of the solvent is adjusted by adding additional component(s) to the solvent prior to entering the absorber or desorber and in which the added additional component(s) are removed downstream the absorber or respective desorber.

16. The process as claimed in claim 11, in which the dielectric constant of the solvent is decreased by adding a component which has a dielectric constant lower than water.

17. The process as claimed in claim 11, in which the dielectric constant of the solvent is increased by adding a component with a high dielectric constant.

18. A system for the removal of acid gas in an acid gas removal process, said system comprising:
(a) an absorber;
(b) a desorber; and
(c) adjustment means adapted to adjust the dielectric constant of a solvent added to the process in order to enhance the performance of the system.

19. The system as claimed in claim 18, in which the dielectric constant of the solvent is changed in the absorber, desorber and/or somewhere else in the process.

20. The system as claimed in claim 18, in which the adjustment of the dielectric constant of the solvent influences the thermodynamic equilibrium of an acid gas removal process and/or the optimal operating temperature in the absorber and/or desorber.

21. The system as claimed in claim 18, in which the dielectric constant of the solvent is adjusted by at least one of the steps selected from the group consisting of:
(a) adding additional component(s) to the solvent prior to entering the absorber or desorber;
(b) applying an electric field to change the dielectric constant of the solvent; and
(c) applying electromagnetic waves adapted to influence the dielectric constant of a solvent.

22. The system as claimed in claim 18, in which the dielectric constant of the solvent is adjusted by adding additional component(s) to the solvent prior to entering the absorber or desorber and in which the added additional component(s) are removed downstream the absorber or respective desorber.

23. The system as claimed in claim 18, in which the dielectric constant of the solvent is decreased by adding a component which has a dielectric constant lower than water.

24. The system as claimed in claim 18, in which the dielectric constant of the solvent is increased by adding a component with a high dielectric constant.

25-27. (canceled)
